(19) United States
(12) Patent Application Publication
(10) Pub. No.: US 2019/0164244 A1
(43) Pub. Date: May 30, 2019

(54) LAW ENFORCEMENT OFFICER REVIEW WEBSITE AND MOBILE APPLICATION

(71) Applicant: Rashad Ghaffar, Lumberton, NC (US)

(72) Inventor: Rashad Ghaffar, Lumberton, NC (US)

(21) Appl. No.: 15/822,228

(22) Filed: Nov. 27, 2017

(51) Int. Cl. G06Q 50/26; G06Q 30/02

(52) U.S. Cl. CPC G06Q 50/26; H04W 4/02; G06Q 30/0282

(57) ABSTRACT

A mobile application to review and rate law enforcement officers running on a mobile device having a display screen and an input unit, the mobile application including a profile section to allow a user to input personal information of the user, and an incident report section to allow the user to generate an incident report by inputting officer encounter information regarding an encounter with a law enforcement officer.

### BACKGROUND OF THE INVENTION

### 1. Field of the Invention

The present general inventive concept relates generally to a website and/or mobile application that can be used by citizens to review law enforcement officers.

### 2. Description of the Related Art

In order to maintain public orders, modern law warrants law enforcement officers (e.g., police officers) to function to protect and serve a city by apprehending criminals, detecting crime, and assisting the general public in affairs or a crisis. However, currently there is limited ways for citizens to advocate their experiences with law enforcement officers.

Therefore, there is a need for a website and/or mobile application that allows citizens to rate and review encounters experienced with law enforcement officers.

### SUMMARY

The present general inventive concept provides a website and/or mobile application that can be used by citizens to review law enforcement officers.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a mobile application to review and rate law enforcement officers running on a mobile device having a display screen and an input unit, the mobile application including a profile section to allow a user to input personal information of the user, and an incident report section to allow the user to generate an incident report by inputting officer encounter information regarding an encounter with a law enforcement officer.

The personal information may include at least one of a username, a name, an age, a gender, a race, an occupation, an address, a phone number, a photograph, a marital status, a number of children, aliases, a prior police record, and an education level.

The officer encounter information may include at least one of an officer name, an officer badge number, a date of an encounter with an officer, a time of an encounter with an officer, a location of an encounter with an officer, a precinct of an officer, an age of an officer, a race of an officer, and a description of an encounter with an officer.

The officer encounter information may further include at least one of uploaded videos of an encounter with an officer and uploaded photographs of an encounter with an officer.

The generated incident report may be uploaded to a precinct corresponding to an officer with whom an encounter was experienced.

The mobile application may further include a GPS section to display a map corresponding to the location of the encounter with the officer.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a mobile device running an application to review and rate law enforcement officers thereon, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

A website and/or mobile application to review and rate law enforcement officers may be a website and/or application that may be accessed using a computer such as a desktop computer, a laptop computer, a tablet computer, or any other type of computing device, or a mobile device, such as a smart phone, a palm pilot, a BLACKBERRY, or any other type of hand-held device. All of the above devices may have an ability to access the Internet via any available wired or wireless technology, and may include components such as a display device (e.g., touch screed, LED, LCD, plasma, etc.), an input unit (e.g., keyboard, touchpad, mouse, etc.), a camera (e.g., video camera, still camera, etc.), a processor, a storage unit, a communication unit, and an output unit (i.e., speakers, etc.).

A user may download the application to review and rate law enforcement officers to at least one computer and/or mobile device. Alternatively, the user may simply access the website to review and rate law enforcement officers via the Internet on the computer and/or mobile device.

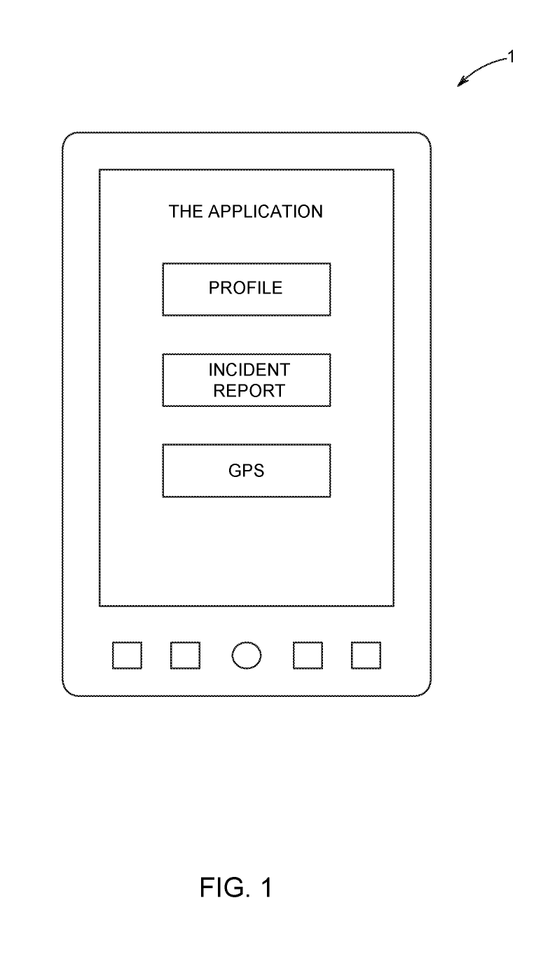

FIG. 1 illustrates a mobile device 1 running an application to review and rate law enforcement officers thereon, according to an exemplary embodiment of the present general inventive concept.

For ease of explanation, the present general inventive concept directed to a website and/or mobile application to review and rate law enforcement officers will be referred to hereinafter as “The Application.”

A purpose of The Application may be to enable citizens to rate and review encounters with law enforcement officers, as well as the law enforcement officers themselves.

The Application may include a “Profile” section to allow users to upload and/or input personal information thereinto, including, but not limited to, username, name, age, gender, race, occupation, address, phone number, photograph, marital status, number of children, aliases, prior police record, and education level. The personal information may be stored within a database connected to The Application.

The Application may include a “Law Enforcement Encounter” section (a.k.a., “Incident Report” section) to allow users to upload and/or input information regarding an encounter with a law enforcement officer. The information regarding an encounter with a law enforcement officer may include, but is not limited to, officer name, officer badge number, date of encounter with officer, time of encounter with officer, location of encounter with officer, precinct of officer, age of officer, race of officer, and description of encounter. The user may input the description of the encounter to describe details of exactly what happened according to a recollection of the user. Also, videos and photos of the encounter may be uploaded. Furthermore, the user may give the officer a rating based on the encounter, and ratings of precincts can also be developed as various officer ratings are input.

The information regarding the encounter with the law enforcement officer may be stored within a database connected to The Application. Moreover, the above information regarding the encounter with the law enforcement officer may be automatically uploaded and sent to the precinct of the officer, so that the officer's superior may have a record of the encounter. Also, the Incident Reports may be shared using MYSPACE, FACEBOOK, INSTAGRAM, and TWITTER, but sharing is not limited thereto.

All of the above inputable information may be provided in predetermined fillable fields, button, and/or drop-down menus.

The Application may include a GPS section that automatically displays and stores a map of an exact location where the encounter with the law enforcement officer occurred. More specifically, a map page may be viewable by users, where indication pins may be displayed on a national, state, region, and/or city map, allowing users to zoom into a locality, such as their personal routes, to visually see exact sites of encounters with law enforcement officers, and click a particular pin to read a corresponding Incident Report, if desired.

After a user inputs details into an Incident Report, a new pin may be viewable on a may of the GPS section, so that other viewers may view the Incident Report.

The application may include a “Search” section that allows users to search law enforcement officers by name, precinct, and/or badge number, in order to view reviews and ratings of particular law enforcement officers that have been previously uploaded by other users.

Accordingly, the present general inventive concept allows users to record interactions and encounters with law enforcement officers, in order to provide reviews and ratings of various officers and precincts as a whole.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A mobile application to review and rate law enforcement officers running on a mobile device having a display screen and an input unit, the mobile application comprising:
a profile section to allow a user to input personal information of the user; and
an incident report section to allow the user to generate an incident report by inputting officer encounter information regarding an encounter with a law enforcement officer.

2. The mobile application of claim 1, wherein the personal information comprises at least one of a username, a name, an age, a gender, a race, an occupation, an address, a phone number, a photograph, a marital status, a number of children, aliases, a prior police record, and an education level.

3. The mobile application of claim 1, wherein the officer encounter information comprises at least one of an officer name, an officer badge number, a date of an encounter with an officer, a time of an encounter with an officer, a location of an encounter with an officer, a precinct of an officer, an age of an officer, a race of an officer, and a description of an encounter with an officer.

4. The mobile application of claim 3, wherein the officer encounter information further comprises at least one of uploaded videos of an encounter with an officer and uploaded photographs of an encounter with an officer.

5. The mobile application of claim 3, wherein the generated incident report is uploaded to a precinct corresponding to an officer with whom an encounter was experienced.

6. The mobile application of claim 3, further comprising a GPS section to display a map corresponding to the location of the encounter with the officer.
